(19) United States
(12) Patent Application Publication
(10) Pub. No.: US 2023/0403209 A1
(43) Pub. Date: Dec. 14, 2023

(54) CONFERENCING SERVICE RATING DETERMINATION

(71) Applicant: VEEGO SOFTWARE LTD., Ramat Gan (IL)

(72) Inventors: Ronen KONDRATOVSKY, Petah Tikva (IL); Sergey VOLKOVICH, Rehovot (IL); Reffael CASPI, Tel Aviv (IL)

(21) Appl. No.: 18/209,009

(22) Filed: Jun. 13, 2023

Related U.S. Application Data
(60) Provisional application No. 63/351,549, filed on Jun. 13, 2022.

(51) Int. Cl. H04L 41/5009; H04L 12/18

(52) U.S. Cl. CPC H04L 41/5009; H04L 12/1831

(57) ABSTRACT

A method comprising: receiving telemetry data representing data connections associated with a conferencing service instance provided to an end-device by a remote conferencing server; selecting a subset of the data connections, based on data traffic measurements; recursively, with respect to each current time window: (i) calculating data rate and packet roundtrip metrics from the telemetry data, (ii) determining a conferencing state of the conferencing service instance, based on the data rate metrics, (iii) determining a current conferencing service score for the conferencing service instance, based on applying respective scoring algorithms to the calculated metrics, wherein the scoring algorithms are selected based on the determined conferencing state, (iv) updating a quality of service (QoS) rating for the conferencing service instance based, at least in part, on the current conferencing service score, and (v) repeating steps (i)-(iv) with respect to a next time window.

### CROSS-REFERENCE TO RELATED APPLICATIONS

This application claims the benefit of priority from U.S. Provisional Patent Application No. 63/351,549, filed Jun. 13, 2022 entitled, “CONFERENCING SERVICE RATING DETERMINATION,” the contents of which are hereby incorporated by reference in their entirety.

### FIELD OF THE INVENTION

The invention relates to the field of data communication networks.

### BACKGROUND

Maintaining an adequate level of service for online services and applications is essential for attracting and retaining customers for these services.

The inherent variability in the quality of service (QoS) achieved by various end devices drives many complaints to network Internet Service Providers (ISPs). In turn, the QoS of the final network segment has a significant effect on the quality of experience (QoE) of three customer operating the end device. For ISPs, the performance of home or residential networks is a particular problem, because it is largely beyond the control of, and invisible to, the ISPs, although it may be the ultimate cause of a large number of calls to ISP helplines.

Different web applications, such as conferencing, gaming, or streaming media, have different traffic patterns and associated Quality of Service (QoS) requirements, such as bandwidth, loss, delay, jitter (variation in delay), and best-effort options.

For instance, conferencing applications are particularly sensitive to the available bandwidth of the internet connection, or the data rate over the connection as measured in bits per second; latency, or the amount of time a data packet uses to make its trip to a remote server and back. Conferencing applications are also sensitive to the rate of packet loss over the connection, which result in loss of data on the user side. Accordingly, to properly determine the QoS experienced by a conferencing user, it is vital for content providers to monitor a set of QoS parameters such as available bandwidth, latency, packet loss, and others, that are essential to this type of service.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, at a communications network interface, telemetry data representing data connections associated with a conferencing service instance provided to an end-device by a remote conferencing server over the Internet, select a subset of the data connections, based on data traffic measurements associated with each of the data connections, recursively, with respect to each current time window: (i) calculate data rate and packet roundtrip metrics from the telemetry data over each data connection in the subset, (ii) determine a conferencing state of the conferencing service instance, based, at least in part, on the data rate metrics, (iii) determine a current conferencing service score for the conferencing service instance, based on applying respective scoring algorithms to the calculated metrics, wherein the scoring algorithms are selected based on the determined conferencing state, (iv) update a quality of service (QoS) rating for the conferencing service instance based, at least in part, on the current conferencing service score, and (v) repeat steps (i)-(iv) with respect to a next time window.

There is also provided, in an embodiment, a computer-implemented method comprising: receiving, at a communications network interface, telemetry data representing data connections associated with a conferencing service instance provided to an end-device by a remote conferencing server over the Internet; selecting a subset of the data connections, based on data traffic measurements associated with each of the data connections; recursively, with respect to each current time window: (i) calculating data rate and packet roundtrip metrics from the telemetry data over each data connection in the subset, (ii) determining a conferencing state of the conferencing service instance, based, at least in part, on the data rate metrics, (iii) determining a current conferencing service score for the conferencing service instance, based on applying respective scoring algorithms to the calculated metrics, wherein the scoring algorithms are selected based on the determined conferencing state, (iv) updating a quality of service (QoS) rating for the conferencing service instance based, at least in part, on the current conferencing service score, and (v) repeating steps (i)-(iv) with respect to a next time window.

There is further provided, in an embodiment, a computer program product comprising a non-transitory computer-readable storage medium having program instructions embodied therewith, the program instructions executable by at least one hardware processor to: receive, at a communications network interface, telemetry data representing data connections associated with a conferencing service instance provided to an end-device by a remote conferencing server over the Internet; select a subset of the data connections, based on data traffic measurements associated with each of the data connections; recursively, with respect to each current time window: (i) calculate data rate and packet roundtrip metrics from the telemetry data over each data connection in the subset, (ii) determine a conferencing state of the conferencing service instance, based, at least in part, on the data rate metrics, (iii) determine a current conferencing service score for the conferencing service instance, based on applying respective scoring algorithms to the calculated metrics, wherein the scoring algorithms are selected based on the determined conferencing state, (iv) update a quality of service (QoS) rating for the conferencing service instance based, at least in part, on the current conferencing service score, and (v) repeat steps (i)-(iv) with respect to a next time window.

In some embodiments the subset of data connections comprises between 1-8 data connections.

In some embodiments, when the determined conferencing state comprises both video and audio transmission, the current conferencing service score is equal to a weighted combination of data connection scores calculated with respect to each of the data connections in the subset.

In some embodiments, with respect to each of the data connections in the subset, the data connection score is a weighted combination of (i) a data rate score calculated based on the data rate metrics, and (ii) a latency score calculated based on the packet roundtrip metrics.

In some embodiments, the data connection score is further based on a packet loss score calculated based on packet loss metrics calculated from the telemetry data over each data connection in the subset, wherein the data connection is a weighted combination of (i) the packet loss score and (ii) the weighted combination of the data rate and latency scores.

In some embodiments, the data connection score is a weighted combination of the data connection scores calculated separately with respect to each of an upstream and a downstream data paths in a respective data connection.

In some embodiments, the determined conferencing state comprises only audio transmission, the current conferencing service score is equal to a weighted combination of latency scores calculated based on the packet roundtrip metrics with respect to each of the data connections in the subset.

In some embodiments, when the determined conferencing state does not comprise video or audio transmission, the current conferencing score is set to a maximum value.

In some embodiments, when the determined conferencing state fluctuates between two or more conferencing states, the current conferencing score is set to a minimum value.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A illustrates an exemplary conferencing network environment between an end-station and a conferencing service or VCS, in accordance with various aspects of the present disclosure;

FIG. 1B illustrates an exemplary conferencing service instance through a conferencing service or VCS which employ a client/server communication model, in accordance with various aspects of the present disclosure;

FIG. 2 shows a block diagram of an exemplary system for real-time monitoring and evaluating of the overall quality of a conferencing service connection, in accordance with some embodiments of the present disclosure; and

FIG. 3 illustrates the functional steps in a method for real-time monitoring and evaluating of the overall quality of a conferencing service connection, in accordance with some embodiments of the present disclosure;

FIG. 4 illustrates an exemplary current time window conferencing status determination, in accordance with some embodiments of the present disclosure; and

FIG. 5A shows an exemplary scoring flowchart, in accordance with some embodiments of the present disclosure; and

FIG. 5B shows an exemplary scoring algorithm flowchart, in accordance with some embodiments of the present disclosure.

### DETAILED DESCRIPTION

Disclosed herein is a technique, embodied in a system, method and computer program product, for real-time monitoring and evaluating of the overall quality of a conferencing service connection. Embodiments described herein are directed to approaches for determining a quality of experience (QoE) of a user of an end-station within a communications network executing an online conferencing application. In some embodiments, the service connection may be a wired or wireless link between a conferencing source over a communication network delivery path to the end-station.

Conferencing, also termed herein videoconferencing, video teleconferencing, or live conferencing, is the two-way or multipoint reception and transmission of audio and video signals by people in different locations for real time communication between the parties. Conferencing is delivered over a communication network among two or more participants, typically with little or no intermediate storage along the network delivery path.

Conferencing experience for participants is dependent on the speed and quality of data transmission over their respective network connections. Data transmission includes a downstream data path and an upstream data path. Downstream paths normally refer to transmission from a web server to a workstation or personal computer user. Upstream data transmission is the opposite with data originating in the workstation or personal computer.

Conferencing service platforms, or Video Conferencing Systems (VCSs), such as Zoom, Teams, and Discord, differ in their general architecture and the manner in which their traffic is routed or redirected. Typically, VCSs employ a client/server communication model. Each client (e.g., an end-station) is both (i) a sender that captures an input feed from a participant (e.g., audio and/or video feed) and encodes it for transmission over the communication network to one or more other participants; and (ii) a receiver that uses a decoder on the data it receives from other participant(s), to provide an output feed consisting of audio and/or video to its corresponding participant. The encoding and decoding processes typically use VCS-specific software, which may compress the data, encrypt it, and/or perform any one or more other processing steps. Each client uses a network connection to reach the VCS server over the Internet. The VCS server processes the data received from a sender client and retransmits it to all receiver clients. Consequently, the data traverses again the Internet and another network connection for each receiver client.

Accordingly, Overall quality-of-service (QoS) provided to a conferencing service user using a typical web connection, is dependent upon both downstream QoS and upstream QoS. The three main issues affecting the performance of conferencing over Internet connections may be defined as:
Bandwidth: The term ‘bandwidth’ has traditionally referred to a measure of capacity, the maximum amount of data that can be transmitted over a link or connection between two points in a communication network. However, maximum notional channel bandwidth does not necessarily indicate the actual effective throughput of the channel, which can be reduced by transmission protocol overhead, encryption, retransmissions, and other factors.
Some conferencing systems are configured to select a conferencing bitrate based on the conferencing bandwidth conditions determined at the client device. For example, media content can be encoded at varying bitrates, each providing for a different level of media resolution and hence quality. Thus, when bandwidth conditions are determined to be deteriorated, the conferencing service may select to stream media encoded at a lower bitrate and resolution, resulting in a decrease in the perceptual quality of the streamed media as perceived by the end user.
Latency: Conferencing applications are sensitive to latency, or the amount of time a data packet uses to make a roundtrip between an end-station and the conferencing service. When latency gets too high, users begin to experience lag in the timing of the speech in the conversation. Such delays may result in confusion and an interruption to the flow of conversation. In a telecommunicated conversation, an increased latency (time lag) larger than about 150-300 ms becomes noticeable and is soon observed as unnatural and distracting. Therefore, next to a stable large bandwidth, a small total round-trip time is another major technical requirement for the communication channel for interactive videoconferencing.
Packet loss: The rate of dataframe loss, i.e., dataframes that should have been forwarded by a network but did not reach their destination. A number of different types of losses may occur, depending on the particular network under consideration. Losses can have a negative effect on the reconstructed video and audio quality. Packet loss may be detected by comparing sequential numbers of downstream control packets sent to client and sequential numbers extracted from upstream packets received from client. The ratio of the number of lost packets to the number of downstream control packets defined a packet-loss ratio.
In this regards, the Internet Protocol (IP) is designed as a best-effort rather than a guaranteed delivery service. Therefore, packet loss over network paths should be taken into consideration when determining QoS. Generally, packet loss occurs when one or more packets of data travelling across a computer network fail to reach their destination. Packet loss is either caused by errors in data transmission, or network congestion. Thus, when reliable delivery is necessary, packet loss increases latency due to the additional time needed for retransmission, which negatively affects user QoE. To avoid some of these issues, the Internet Protocol allows for routers to drop packets if the router or a network segment is too busy to deliver the data in a timely fashion. The dropping of packets by network nodes provides an indication to senders that the network is congested.

In a non-limiting example, the present disclosure may operate within the context of a local area network (LAN) comprising one or more end-devices, e.g., end stations (STAs). A LAN may be connected to the Internet through an access point (AP) and/or a gateway, such as a broadband modem and/or router. In a typical LAN environment, a user may access the Internet by connecting a client device (which may be a wireless device) to a server on the Internet, via intermediate devices and networks. In some implementations, a client device may be connected to a LAN configured to communicate with servers on a wide area network (e.g., the Internet) via an access network. In some embodiments, a LAN may be a wireless local area network (WLAN), which includes, e.g., wireless STAs connected through a wireless AP, e.g., a wireless router. In some embodiments, STAs within a LAN can be, but are not limited to, a tablet, a desktop computer, a laptop computer, a handheld computer, a smartphone, or a combination of any these data processing devices or other data processing devices.

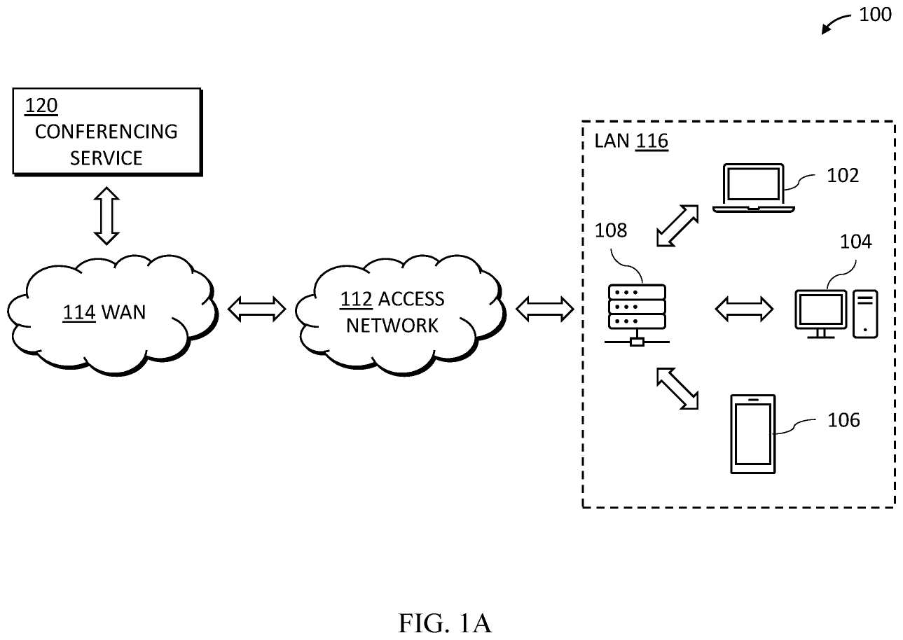

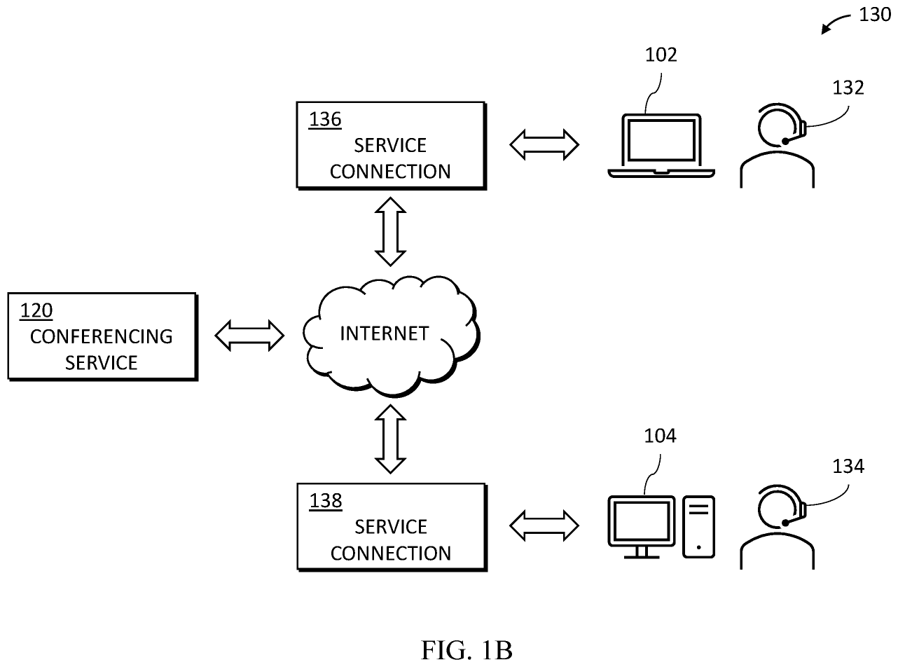

FIG. 1A illustrates an exemplary conferencing network environment 100 between an end-station and a conferencing service or VCS, in which the present technique for real-time monitoring and evaluating of the overall quality of a conferencing service connection may be deployed, according to some embodiments of the present disclosure.

Conferencing network environment 100 includes one or more conferencing-enabled devices, e.g., end-stations (STAs) 102 (a laptop computer), 104 (a desktop computer) and/or 106 (a smartphone), communicably connected to conferencing service platform 120 via local area network (LAN) 116, access network 112 and wide area network 114. However, each of STAs 102-106 can represent any of several forms of computing devices, e.g., any handheld device, a tablet, a cellular telephone, a media player, or a combination of any these devices. Typically, a conferencing-enabled device will be configured to run one or more VCS-specific applications, such as Zoom, Teams, etc.

LAN 116 includes AP 108 and STAs 102-106. LAN 116 may be connected with the access network via a broadband modem. LAN 116 can include any computer network that covers a limited geographic area (e.g., a home, school, computer laboratory, or office building) using a wired or wireless (WLAN) distribution method. Client devices (e.g., STAs 102-106) may associate with an AP (e.g., AP 108) to access LAN 116 using any suitable communication protocol or standard. For example, LAN 116 may be a WLAN, e.g., a Wi-Fi network.

For exemplary purposes, LAN 116 is illustrated as including multiple STAs 102-106; however, LAN 116 may include only one of STAs 102-106. In some implementations, LAN 116 may be, or may include, one or more of a bus network, a star network, a ring network, a relay network, a mesh network, a star-bus network, a tree or hierarchical network, and the like.

AP 108 can include a network-connectable device, such as a hub, a router, a switch, a bridge, or any other access point. The network-connectable device may also be a combination of devices, such as a Wi-Fi router that can include a combination of a router, a switch, and an AP. Other network-connectable devices can also be utilized in implementations of the subject technology. AP 108 can allow client devices (e.g., STAs 102-106) to connect to wide area network 114 via access network 112.

In some aspects, STAs 102-106 may communicate through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, Wi-Fi, or other such transceiver.

Conferencing service platform 120 may be a system or device having a processor, a memory, and communications capability for providing content and/or services to the STAs in the conferencing and/or other and/or additional service categories. In some example aspects, conferencing service platform 120 can be a single computing device, for example, a computer server. In other embodiments, conferencing service platform 120 can represent more than one computing device, e.g., multiple servers, working together to perform the actions of a conferencing service platform (e.g., using cloud computing). Further, conferencing service platform 120 can represent various forms of internet service platform including, but not limited to, an application server, a proxy server, a network server, an authentication server, an electronic messaging server, a content server, a server farm, etc.

A user may interact with the content and/or services provided by conferencing service platform 120 through a client application installed at STAs 102-106. Alternatively, the user may interact with the system through a web browser application at STAs 102-106. Communication between STAs 102-106 and conferencing service platform 120 may be facilitated through LAN 116, access network 112 and/or wide area network 114.

Access network 112 can include, but is not limited to, a cable access network, public switched telephone network, and/or fiber optics network to connect wide area network 114 to LAN 116. Access network 112 may provide last mile access to the Internet. Access network 112 may include one or more routers, switches, splitters, combiners, termination systems, central offices for providing broadband services.

Wide area network 114 can include, but is not limited to, a large computer network that covers a broad area (e.g., across metropolitan, regional, national or international boundaries), for example, the Internet, a private network, a cellular network, or a combination thereof connecting any number of mobile clients, fixed clients, and servers. Further, wide area network 114 can include, but is not limited to, any of the following network topologies, including a bus network, a star network, a ring network, a mesh network, a star-bus network, tree or hierarchical network, and the like. Wide area network 114 may include one or more wired or wireless network devices that facilitate device communications between STAs 102-106 and conferencing service platform 120, such as switch devices, router devices, relay devices, etc., and/or may include one or more servers.

FIG. 1B illustrates an exemplary conferencing service instance 130, provided through conferencing service or VCS 120, which employs a client/server communication model. For example, a first participant 132 may generate an input feed (e.g., audio and/or video) over STA 102, which may be a laptop computer running a suitable conferencing application specific to conferencing service or VCS 120. STA 102 encodes the input feed for transmission over a service connection 136 (which may include LAN 116, access network 112, and/or WAN 114, shown in FIG. 1A), and through the Internet, to conferencing service or VCS 120. Conferencing service or VCS 120 processes the data received from STA 102, and retransmits it to all receiver clients, e.g., to a second participant 134 using STA 104, over service connection 138 which connects STA 104 to the Internet. STA 104 decodes the data it receives, to provide an output feed consisting of audio and/or video to participant 134. The encoding and decoding performed by the sender and receiver clients typically uses VCS-specific software, which may compress the data, encrypt it, and/or perform any one or more other processing steps.

In a non-limiting example, the present technique provides for modifying an online conferencing network, such as exemplary conferencing network environment 100, to incorporate the present technique. For example, an agent of the present disclosure may be added to conferencing network environment 100 to obtain the desirable features the present disclosure. In some embodiments, an agent of the present disclosure may be integrated as a node of conferencing network environment 100, for example, within access network 112a, AP 108, or otherwise. The present agent monitors and analyzes the data traffic over a conferencing service connection to determine a set of features associated with the service connection. The agent then assigns a score to the connection, based on the determined features.

Accordingly, in some embodiments, the present technique provides for an agent which continuously monitors a conferencing service instance (which may comprise one or more individual data connections) over a conferencing network, to continuously evaluate the data traffic performance of the network path from sender to target. In some embodiments, the present technique provides for monitoring a conferencing network path throughput, bandwidth, response time, and/or latency, to determine a plurality of parameters associated with the amount of time required for a packet to travel across a network path from sender to target in both ways.

In some embodiments, the present technique specially measures the following parameters:
Data rate or byterate: The maximum amount of data that can be transmitted over a link or connection between two points in a communication network, which may be measured in bits per second (bps) or in bytes per second (8 bits per second), sometimes with a multiplier, such as K (for thousands), M (for millions), or G (for billions).
Latency: The amount of time a data packet uses to make a roundtrip to the conferencing service and back.
Packet loss: The rate of dataframe loss, i.e., dataframes that should have been forwarded by a network but did not reach their destination. Packet loss may be detected by comparing sequential numbers of downstream control packets sent to client and sequential numbers extracted from upstream packets received from client. The ratio of the number of lost packets to the number of downstream control packets defined a packet-loss ratio.

In some embodiments, the present technique uses these parameters to calculate and assign an overall quality score to the conferencing service instance. In some examples, the service instance quality score can be represented on a scale of between 0-100, or using any other suitable scoring scale. In some embodiments, the service instance quality score may then allow the present technique to assess an overall Quality of Experience (QoE) associated with the conferencing service instance, based on a scoring scale of 0-100:
Satisfactory Status (Score 75-100): The conferencing service instance provides a satisfactory level of QoE.
Advisory Status (Score 50-74): The conferencing service instance generally provides an adequate level QoE, however, the QoE is unstable and may be negatively impacted in the case of an increase in network data traffic or similar factors.
Critical Status (Score 25-49): The conferencing service instance provides an inadequate level of QoE.
Inoperative Status (Score 0-24): The conferencing service instance is inoperative, such that an end-deice is unable to connect to a conferencing platform, experiences frequent disconnections, and/or is unable to execute a conferencing application which requires a real-time data connection.

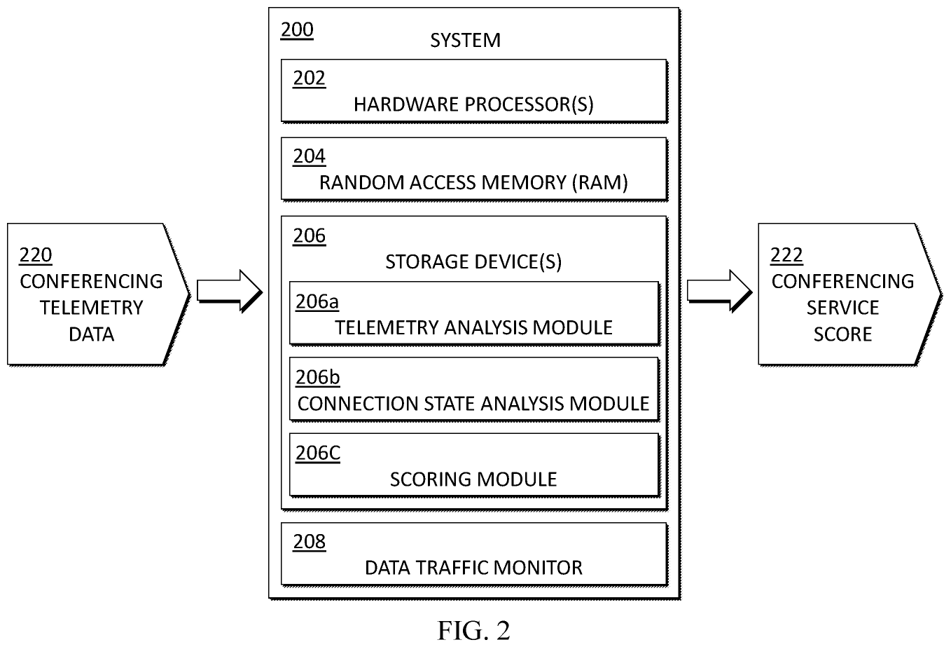

FIG. 2 shows a block diagram of an exemplary system 200 for real-time monitoring and evaluating of the overall quality of a conferencing service connection, according to some embodiments of the present disclosure.

System 200 may include one or more hardware processor(s) 202, a random-access memory (RAM) 204, one or more non-transitory computer-readable storage device(s) 206, and a data traffic monitor 208. Components of system 200 may be co-located or distributed, or the system may be configured to run as one or more cloud computing ‘instances,’ ‘containers,’ ‘virtual machines,’ or other types of encapsulated software applications, as known in the art.

Storage device(s) 206 may have stored thereon program instructions and/or components configured to operate hardware processor(s) 202. The program instructions may include one or more software modules, such as telemetry analysis module 206a, connection state analysis module 206b, and scoring module 206c. The software components may include an operating system having various software components and/or drivers for controlling and managing general system tasks (e.g., memory management, storage device control, power management, etc.), and facilitating communication between various hardware and software components. System 200 may operate by loading instructions of the various software module 206a, connection state analysis module 206b, and/or scoring module 206c into RAM 204 as they are being executed by processor(s) 202.

Data traffic monitor 208 may be configured to continuously monitor one or more conferencing service instances over a data communications network. Data traffic monitor 208 may monitor and collect input conferencing telemetry data 220, including, but not limited to, data packets, user data, or control information associated with various information channels (e.g., control channels, data channels, and information related to managing service discovery over network connections). Conferencing telemetry data 220 received at data traffic monitor 208 may be processed and transmitted to telemetry analysis module 206a and/or to other components of system 200.

In some embodiments, data traffic monitor 208 may monitor and capture telemetry data, captured through active and/or passive probing of endpoint devices. In some embodiments, probing by data traffic monitor 208 may entail sending one or more of the following probes:
DHCP probes with helper addresses.
SPAN probes, to get messages in INIT-REBOOT and SELECTING states, use of ARP cache for IP/MAC binding, etc.
Netflow probes.
HTTP probes to obtain information such as the OS of the device, Web browser information, etc.
RADIUS probes.
SNMP to retrieve MIB object or receives traps.
DNS probes to get the Fully Qualified Domain Name (FQDN).
Active or SNMP scanning to retrieve the MAC address of a device or other types of information.

In some embodiments, telemetry data captured by data traffic monitor 208 may also include data packets, user data, or control information associated with various information channels (e.g., control channels, data channels, and information related to managing service discovery over network connections). Information received at data traffic monitor 208 may be processed and transmitted to telemetry analysis module 206a and/or to other components of system 200.

In some embodiments, data traffic monitor 208 may be completely software based, hardware based, or a combination of both. Data traffic monitor 208 may comprise one or more monitoring points, which may be implemented in software and/or hardware devices distributed over a plurality of network nodes. In some cases, data traffic monitor 208 may be implemented by a vendor, such as an ISP, to monitor network data traffic over a backbone or access network, where the data traffic is associated with a plurality of LANs serviced by the ISP.

In some embodiments, input conferencing telemetry data 220 captured by data traffic monitor 208 originate in wired networks, but can also originate in wireless networks and virtual environments. In some examples, data traffic monitor 208 may include a circuit or circuitry for monitoring and identifying one or more attributes of a connection. In some embodiments, data traffic monitor 208 may be configured to monitor and determine, e.g., connection throughput (e.g., connection bitrate, byterate, packets per second, etc.). In some embodiments, data traffic monitor 208 may comprise a ‘sniffer’ or network analyzer designed to capture telemetry data on a network. In some embodiments, data traffic monitor 208 may employ any suitable hardware and/or software tool to capture telemetry data samples. For example, data traffic monitor 208 may be deployed to monitor one or more access networks, access points, end devices, and/or hosts, to capture telemetry data sent to or received from the Internet. In some embodiments, data traffic monitor 208 may be configured to determine a corresponding source or application associated with captured telemetry data. In some embodiments, data traffic monitor 208 may be configured to timestamp and label captured telemetry data with its associated source or application.

In some embodiments, telemetry analysis module 206a may be configured to receive input conferencing telemetry data 220, as captured by data traffic monitor 208, and to preprocess and/or process and analyze the input conferencing telemetry data 220 according to any desirable or suitable analysis technique, procedure or algorithm. In some embodiments, telemetry analysis module 206a may be configured to perform any one or more of the following: data cleaning, data filtering, data normalizing, and/or feature extraction and calculation. In some embodiments, the instructions of telemetry analysis module 206a cause system 200 to calculate and output an overall quality score 222 associated with the service connection.

In some embodiments, connection state analysis module 206b is configured to divide conferencing telemetry data 220 into consecutive time windows, to categorize each of the time windows into one of a set of state categories, and to calculate statistical metrics over each of the time windows.

In some embodiments, scoring module 206c is configured to continuously calculate and output an overall quality score 222 on a scale of 0-100 associated with a current conferencing service instance.

System 200 as described herein is only an exemplary embodiment of the present invention, and in practice may be implemented in hardware only, software only, or a combination of both hardware and software. In various embodiments, system 200 may comprise a dedicated hardware device, or may be implement as a hardware and/or software module into an existing device, e.g., an AP, such as AP 108 within LAN 116 shown in FIG. 1A, or may be part of a remote server, e.g., conferencing service platform 120 shown in FIG. 1A. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 200 may be co-located or distributed, or the system may be configured to run as one or more cloud computing ‘instances,’ ‘containers,’ ‘virtual machines,’ or other types of encapsulated software applications, as known in the art.

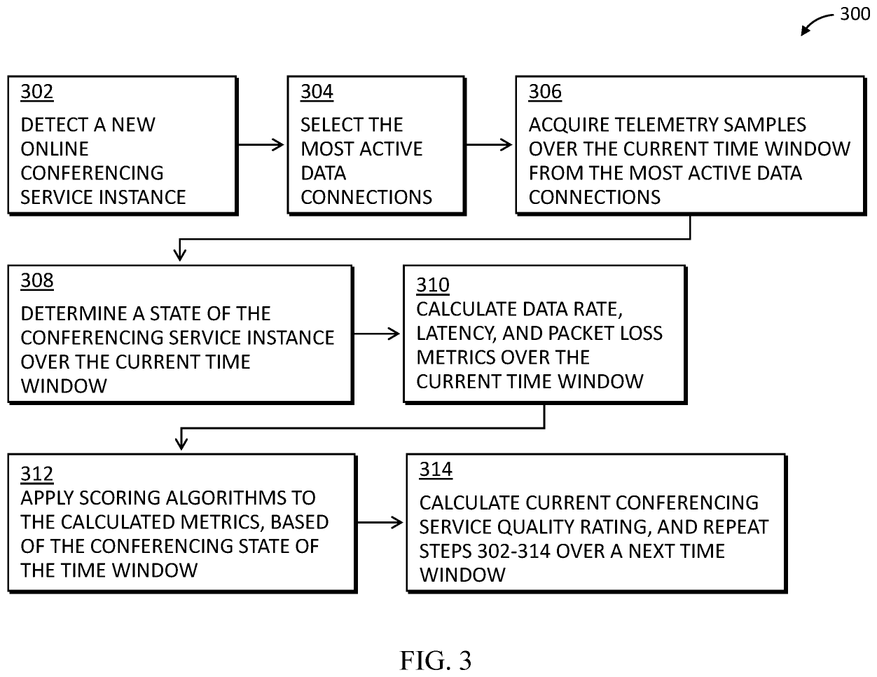

The instructions of system 200 will now be discussed with reference to the flowchart of FIG. 3 which illustrates the functional steps in a method 300 for real-time monitoring and evaluating of the overall quality of a conferencing service connection, according to some embodiments of the present disclosure. The various steps of method 300 will be described with continuous reference to exemplary conferencing network environment 100 shown in FIG. 1A, and exemplary system 200 shown in FIG. 2.

The various steps of method 300 may either be performed in the order they are presented or in a different order (or even in parallel), as long as the order allows for a necessary input to a certain step to be obtained from an output of an earlier step. In addition, the steps of method 300 may be performed automatically (e.g., by system 200 of FIG. 2), unless specifically stated otherwise. In addition, the steps of FIG. 3 are set forth for exemplary purposes, and it is expected that modification to the flow chart is normally required to accommodate various network configurations and network carrier business policies.

In some embodiments, the steps of method 300 may be performed recursively, over consecutive time windows, over all or part of the duration of an online conferencing service instance. In some embodiments, the time windows have a duration of, e.g., between 1-240 seconds. However, other time windows having durations that are shorter or longer may be used. In some embodiments, the time windows over which the steps of method 300 are performed recursively may partly overlap.

Method 300 begins in step 302, when an end user transmits a conferencing session request. For example, with reference to FIG. 1A, an end user using STA 102 (e.g., a laptop computer) within LAN 116 may transmit a request to establish a new conferencing service connection with conferencing service platform 120.

In some cases, the conferencing service resources may be deployed across one or more associated domains, e.g., multiple domains. In such cases, in order to fetch the service, STA 102 must open two or more parallel data connections associated with the multiple resources comprising the requested service. Thus, a conferencing service connection may comprise multiple active connections collectively providing a single conferencing service instance.

In some embodiments, the instructions of data traffic monitor 208 may cause system 200 to detect a new conferencing service instance which includes one or more data traffic connections established within the context of the conferencing network environment. As an example, system 200 or a portion thereof may be implemented, e.g., as a dedicated hardware device, or may be implement as a hardware and/or software module into an existing device, e.g., an AP, such as AP 108 within LAN 116 shown in FIG. 1A, or may be part of a remote server, e.g., conferencing service platform 120 shown in FIG. 1A. Specifically, the instructions of data traffic monitor 208 may cause system 200 to detect a new conferencing service instance, and to continuously monitor the one or more data connections associated with the conferencing service instance.

In some embodiments, the instructions of data traffic monitor 208 may cause system 200 to determine whether the service instance is associated with conferencing. For example, system 200 may be configured to determine that a new service instance is associated with conferencing based on connection parameters such as, but not limited to, domain name, IP address, and/or port numbers. In some embodiments, system 200 may perform these checks with respect to each of the multiple data connections associated with the service instance. In some embodiments, system 200 may be configured to determine that a new service instance is associated with online conferencing, based on a trained machine learning model classifier configured to output a classification of input telemetry data as belonging to one or more specified service categories, e.g., conferencing.

In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out by data traffic monitor 208 to determine the domain name associated with an IP address. In other examples, data traffic monitor 208 may determine port numbers associated the IP address, and/or a transport protocol, e.g., Transmission Control Protocol (TCP) and the User Datagram Protocol (UDP). In the case of port number ranges, because many Internet resources use a known port or port ranges on their local host as a connection point to which other hosts may initiate communication, data traffic monitor 208 may analyze TCP SYN packets to know the server side of a new client-server TCP connection.

In some embodiments, associating a service instance with conferencing may be based on a URL or a server IP address associated with a known domain found, e.g., in repository of domain names associated with conferencing. For example, known domain names associated with conferencing may be identified and added to a database of domain name maintained by system 200, e.g., on storage device 206. In some embodiments, such detection may be further supported by, e.g., an expression or a string (e.g., a regex) which may be associated with a particular conferencing application or service provider, an expected port range associated with the service type, or an expected protocol associated with the service provider.

In some embodiments, a database of known domain names associated with conferencing online may be obtained using, e.g., a dedicated crawler configured to systematically browses the Internet for the purpose of identifying and indexing domain names based on a type, content, etc. A crawler typically travels over the Internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA in LAN 116 may be matched with an entry in a domain repository maintained by system 200. In such case, the service may be determined to be a category of service associated with the matched domain name.

In some embodiments, system 200 may be configured to determine that a new service instance is associated with conferencing by applying one or more trained machine learning models configured to perform a classification task which classifies data traffic as belonging to conferencing service category.

With reference back to FIG. 3, in step 304, the instructions of data traffic monitor 208 may cause system 200 to select, for a current time window, a subset comprising the most active data connections from among the one or more data connections which may be associated with the conferencing service instance detected in step 302. In some embodiments, the instructions of data traffic monitor 208 may cause system 200 to select the single most active data connection from among the data connections which may be associated with the conferencing service instance detected in step 302. In some embodiments, the instructions of data traffic monitor 208 may cause system 200 to select the top two most active data connections from among the data connections which may be associated with the conferencing service instance detected in step 302. In some embodiments, the instructions of data traffic monitor 208 may cause system 200 to select another specified number of the most active data connections from among the data connections which may be associated with the conferencing service instance detected in step 302, such as between 3-8 data connections.

In some embodiments, selecting the most active data connections may be based, at least in part, on maximum and/or average upstream and downstream data traffic measured over each individual data connection making up the conferencing service instance. In some embodiments, the data traffic may be measured in bits per second, bytes per second, and/or packets per second. In some embodiments, detecting data connection activity may be performed continuously in real time, over consecutive time windows of predetermined duration. In some embodiments, the consecutive time windows may have a duration between 1-240 seconds.

In some embodiments, in step 304, the instructions of telemetry analysis module 206a may cause system 200 to further verify whether the most active data connections meet minimum activity data traffic thresholds, e.g., based on maximum and/or average upstream and downstream data traffic measured over each connection. In some embodiments, such minimum activity data traffic thresholds may be applied separately with respect to upstream and downstream data traffic.

With continued reference to FIG. 3, in step 306, the instructions of data traffic monitor 208 may cause system 200 to capture telemetry data samples and related data connection metrics over a current time window, from the most active data connections identified in step 304. In some embodiments, step 306 may comprise acquiring telemetry samples and data connection metrics over the current time window, from only the most active data connection from among the data connections which may be associated with the conferencing service instance detected in step 302.

In some embodiments, step 306 may comprise acquiring telemetry samples and related data connection metrics over the current time window, from the top two most active data connections from among the data connections which may be associated with the conferencing service instance detected in step 302. In some embodiments, step 306 may comprise acquiring telemetry samples and data connection metrics over the current time window, from another specified number of the most active data connections from among the data connections which may be associated with the conferencing service instance conferencing detected in step 302, such as between 3-8 most active data connections.

In some embodiments, the instructions of data traffic monitor 208 may cause system 200 to measure data traffic rates over a current time window, from the most active data connections identified in step 304. In some embodiments, data traffic rates measurements may be performed at specified sampling intervals of between, e.g., 0.01-240 seconds, e.g., every 2 seconds, or at any other desired interval. In some embodiments, the instructions of data traffic monitor 208 may cause system 200 to continuously acquire and store, in real time, the results of the data rate measurements, e.g., in a repository on storage device 206.

For example, the instructions of data traffic monitor 208 may cause system 200 to conduct repeated ping tests over the current time window, with respect to the most active data connection from among the data connections which may be associated with the conferencing service instance detected in step 302. In some embodiments, the instructions of data traffic monitor 208 may cause system 200 to conduct repeated ping tests over the current time window, with respect to the top two most active data connections from among the data connections which may be associated with the conferencing service instance detected in step 302. In other embodiments, the instructions of data traffic monitor 208 may cause system 200 to conduct repeated ping tests over the current time window, with respect to another specified number of the most active data connections from among the data connections which may be associated with the conferencing service instance detected in step 302, such as between 3-8 most active data connections.

In each such case, the ping tests may be performed repeatedly. For example, the ping tests may be repeated at intervals of between 0.01-240 seconds over the current time window, or at any other desired interval over the current time window. In some embodiments, the instructions of data traffic monitor 208 may cause system 200 to continuously acquire and store, in real time, the results of the ping test measurements over the current time window with respect to the one or more most active data connections, e.g., in a repository on storage device 206.

In some embodiments, the instructions of data traffic monitor 208 may cause system 200 to employ a traceroute and/or a similar utility that traces a packet from source to destination, and shows the number of steps (hops) required to reach there, along with the duration of each step (hop). Traceroute and/or similar utilities work by sending packets of data with a low survival time (Time to Live—TTL) which specifies how many steps (hops) can the packet survive before it is returned. When a packet cannot reach the final destination and expires at an intermediate step, that node returns the packet and identifies itself. Thus, by increasing the TTL gradually, the trace is able to identify the intermediate hosts. If any of the hops comes back with a “request timed out,” this may denote network congestion and a reason for slow loading Web pages and dropped connections.

Accordingly, in some embodiments, the instructions of data traffic monitor 208 may cause system 200 to conduct repeated traceroute tests over the current time window, with respect to the one or more data connections comprising the conferencing service instance detected in step 302. For example, the instructions of data traffic monitor 208 may cause system 200 to conduct repeated traceroute tests over the current time window, with respect to the most active data connection from among the data connections which may be associated with the conferencing service instance detected in step 302. In some embodiments, the instructions of data traffic monitor 208 may cause system 200 to conduct repeated traceroute tests over the current time window, with respect to the top two most active data connections from among the data connections which may be associated with the conferencing service instance detected in step 302. In other embodiments, the instructions of data traffic monitor 208 may cause system 200 to conduct repeated traceroute tests over the current time window, with respect to another specified number of the most active data connections from among the data connections which may be associated with the conferencing service instance detected in step 302, such as between 3-8 most active data connections.

In each such case, the traceroute tests over the one or more data connections may be performed continuously over the current time window. In some embodiments, the traceroute tests over one or more data connections may be repeated at intervals of between 0.01-240 seconds over the current time window, with respect to, or at any other desired interval over the current time window, with respect to. In some embodiments, the instructions of data traffic monitor 208 may cause system 200 to continuously acquire and store, in real time, the results of traceroute measurements over the current time window, with respect to the one or more data connections, e.g., in a repository on storage device 206.

For example, the instructions of data traffic monitor 208 may cause system 200 to acquire packet loss rates over the current time window, with respect to the most active data connection from among the data connections which may be associated with the conferencing service instance detected in step 302. In some embodiments, the instructions of data traffic monitor 208 may cause system 200 to acquire packet loss rates over the current time window, with respect to the top two most active data connections from among the data connections which may be associated with the conferencing service instance detected in step 302. In other embodiments, the instructions of data traffic monitor 208 may cause system 200 to acquire packet loss rates over the current time window, with respect to another specified number of the most active data connections from among the data connections which may be associated with the conferencing service instance detected in step 302, such as between 3-8 most active data connections.

In each such case, packet loss measurements may be performed continuously over a current time window. In some embodiments, the packet loss measurements over a current time window may be repeated at time intervals of between 0.01-240 seconds, or at any other desired interval. In some embodiments, the instructions of data traffic monitor 208 may cause system 200 to continuously acquire and store, in real time, the results of packet loss measurements over a current time window, e.g., in a repository on storage device 206.

In each such case, packet loss may be measured as a rate of dataframe loss, i.e., the percentage of dataframes that should have been forwarded by a network but were not. Thus, for example, packet loss rate measurements may be based on a ratio of ping and/or traceroute messages that failed to reach their destination and/or timed-out. Accordingly, if 100 ping and/or traceroute tests are conducted within a current time window, but only 70 were received in their respective destination, this indicated a packet loss rate of 30%.

In some embodiments, step 306 may be carried out by data traffic monitor 208, which may be configured to acquire telemetry data and related data traffic parameters associated with the current conferencing service instance detected in step 302, over the one or more data connections comprising the conferencing service instance. The data traffic parameters may be obtained, e.g., from packet header information (obtained either through operating system files or data traffic sniffing), including, e.g., the IP source, destination, and port numbers. In the case of port number ranges, because many Internet resources use a known port or port ranges on their local host as a connection point to which other hosts may initiate communication, data traffic monitor 208 may analyze TCP SYN packets to know the server side of a new client-server TCP connection.

In some embodiments, data traffic monitor 208 may be configured to capture telemetry data associated with a one or more data connections over a data communications network or any other similar communications platform for carrying or transferring data over network links between one or more network nodes (e.g., terminals, gateways, routers, etc.). Such telemetry data may involve a particular service instance for a particular device/client application or client service, such as a conferencing session. Conferencing telemetry data further may be carried or communicated via any of various different data communications protocols, such as Transmission Control Protocol over Internet Protocol (TCP/IP), User Datagram Protocol over IP (UDP/IP), etc., and may also involve other information systems session protocols such as Hypertext Transfer Protocol (HTTP) or Hypertext Transfer Protocol Secure (HTTPS). However, the principles of the example embodiments of the present invention are equally applicable to any network data traffic irrespective of the particular protocols employed.

In some embodiments, the instructions of data traffic monitor 208 may cause system 200 to employ one or more data connection tracking tools, to determine such data traffic parameters, measurements and/or statistics of the connection. In some embodiments, such tools may provide such information with respect to application protocols such as FTP, TFTP, IRC, and PPTP. In some embodiments, such tools provide the ability to monitor and handle data packets at different stages, e.g., pre-routing, local input, forward, local output, and/or post-routing.

With reference back to FIG. 3, in step 308, the instructions of connection state analysis module 206b may cause system 200 to classify the current time window into one of a set of conferencing connection state categories, based, at least in part, on predefined rules pertaining to data traffic rate metrics (e.g., packet rate and/or byterate) over the associated individual data connections comprising the current conferencing service instance over the current time window. For example, connection state analysis module 206b may cause system 200 to determine packet rates and/or byterate over any of the associated individual data connections, relative to predefined minimum and/or maximum thresholds.

In some embodiments, the instructions of connection state analysis module 206b may cause system 200 to initially set the conferencing connection state with respect to the current time window, to an initial state of “unknown.” The instructions of connection state analysis module 206b may then cause system 200 to apply one or more predefined rules to the data rate metrics, to determine a conferencing connection state with respect to the current time window, as one of:
Unstable: The conferencing connection state fluctuates between two or more conferencing connection states during the time window.
Idle: No data traffic associated with video or audio transmission is detected.
Video: Data traffic associated with both video and audio transmission is detected.
Audio only: Data traffic associated with only audio transmission is detected.

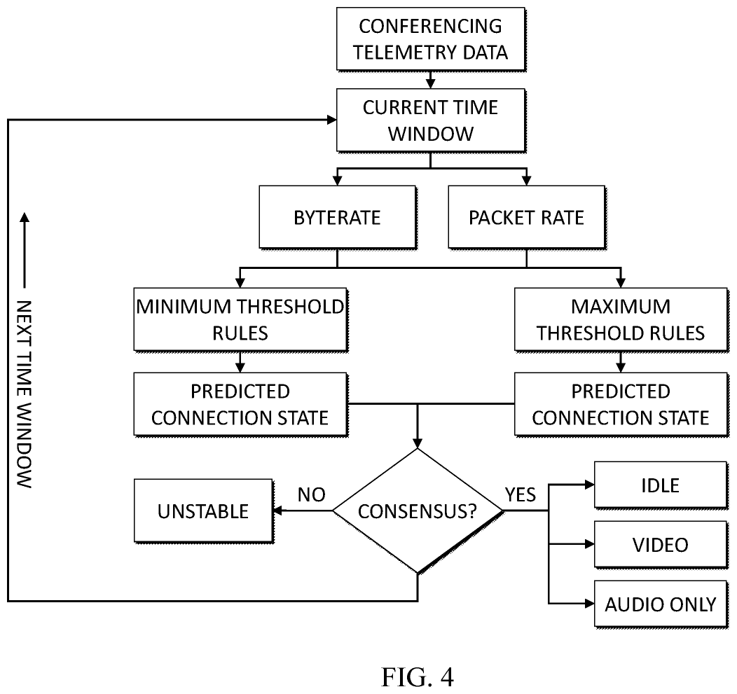

FIG. 4 illustrates an exemplary current time window conferencing connection state determination. As can be seen, data traffic associated with the current time window is analyzed based on predefined rules pertaining to packet rate and byterate. In some embodiments, the predefined rules and/or thresholds may be VCS-specific, such that connection state analysis module 206b may cause system 200 to apply predefined rules that are specific to a conferencing application (e.g., Zoom, Teams) detected in step 302.

In some embodiments, two concurrent analyses may be performed, based on predefined rules pertaining to packet rate and byterate, respectively. When the results of the concurrent analyses represent a consensus, the current time window is categorized according to the consensus determination. When the results of the concurrent analyses disagree with one another, the current time window is categorized as ‘unstable.’

In some embodiments, connection state analysis module 206b may cause system 200 to store, e.g., in a state repository on storage device 206, data related to the time windows and their associated determined conferencing state, including a time window state category, duration, total number of bytes transmitted during the time window, and total number of packets transmitted during the time window.

With reference back to FIG. 3, in step 310, the instructions of telemetry analysis module 206a may cause system 200 to use the telemetry data acquired in step 306, to calculate metrics with respect to at least data rates, latency, and packet loss for the current time window, over each of most active individual data connections identified in step 304.

In some embodiments, the instructions of telemetry analysis module 206a may cause system 200 to use the data rate, latency, and packet loss measurements acquired in step 306 to calculate at least some of the following metrics over the current time window:
Mean, average, maximum, minimum, and standard deviation of the byterate;
mean, average, maximum, minimum, and standard deviation of the packet rate;
mean, average, maximum, minimum, and standard deviation of packet roundtrip time;
mean, average, maximum, minimum, and standard deviation of packet loss rate;

In some embodiments, in step 312, the instructions of scoring module 206c may cause system 200 to apply one or more scoring algorithms to the statistical metrics calculated in step 310 with respect to the current time window, to calculate one or more corresponding current conferencing service scores. In some embodiments, the scoring algorithms selected for application by scoring module 206c may be determined based on the predicted conferencing connection state of current time window, as determined in step 310.

In an exemplary calculation detailed hereinbelow, the instructions of scoring module 206c may cause system 200 to apply the one or more scoring algorithms separately to the statistical metrics of the top two most active data connections from among the data connections which may be associated with the conferencing service instance detected in step 302. However, a similar calculation may be applied with respect to only the single most active data connection, or another specified number of the most active data connections, such as between 3-8 data connections. In some embodiments, the instructions of scoring module 206c may cause system 200 to combine the results of all of the applications of the one or more scoring algorithms to the individual data connections. In some embodiments the combined score may be based on applying a predefined function, or by applying predefined weights, to produce a current conferencing service score 222. In some embodiments, the score may be on a scale of 0-100.

In another exemplary calculation detailed hereinbelow, the instructions of scoring module 206c may cause system 200 to apply the one or more scoring algorithms separately to the statistical metrics of each data stream path, i.e., upstream and downstream data paths, wherein this application is repeated separately over the top two most active data connections, as described immediately above. However, a similar calculation may be applied with respect to only the single most active data connection, or another specified number of the most active data connections, such as between 3-8 data connections. In some embodiments, the instructions of scoring module 206c may cause system 200 to first combine the results of the applications of the one or more scoring algorithms to the upstream/downstream date paths within each individual data connection. In some embodiments the combined score may be based on applying a predefined function, or by applying predefined weights, to produce a current data connection score for each individual data connection. In some embodiments, the score may be on a scale of 0-100. In some embodiments, the combined data path score within each data connection may be then combined over the top two most active data connections, as described above. However, a similar calculation may be applied with respect to only the single most active data connection, or another specified number of the most active data connections, such as between 3-8 data connections.

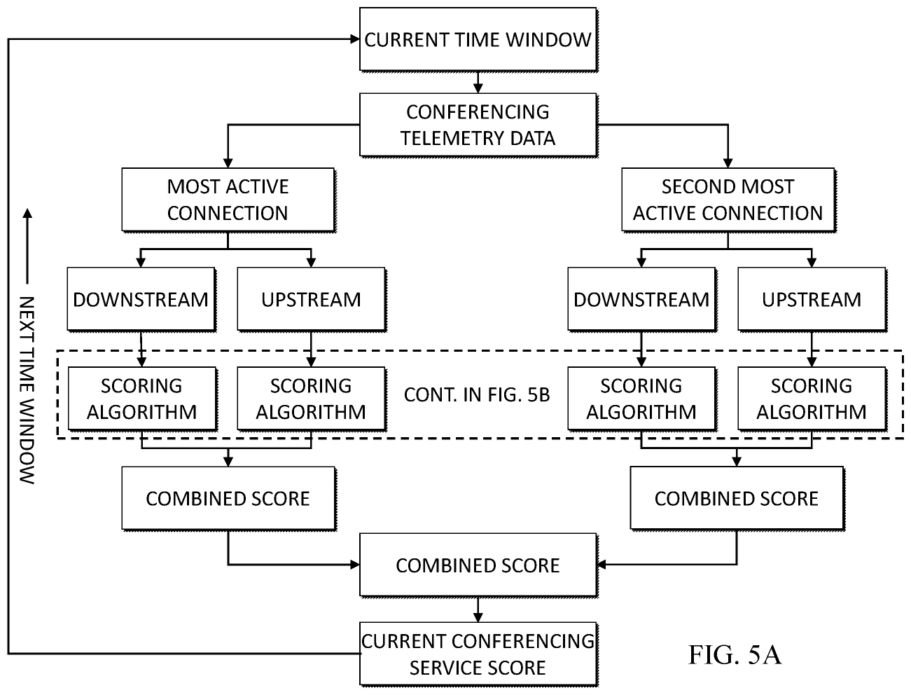

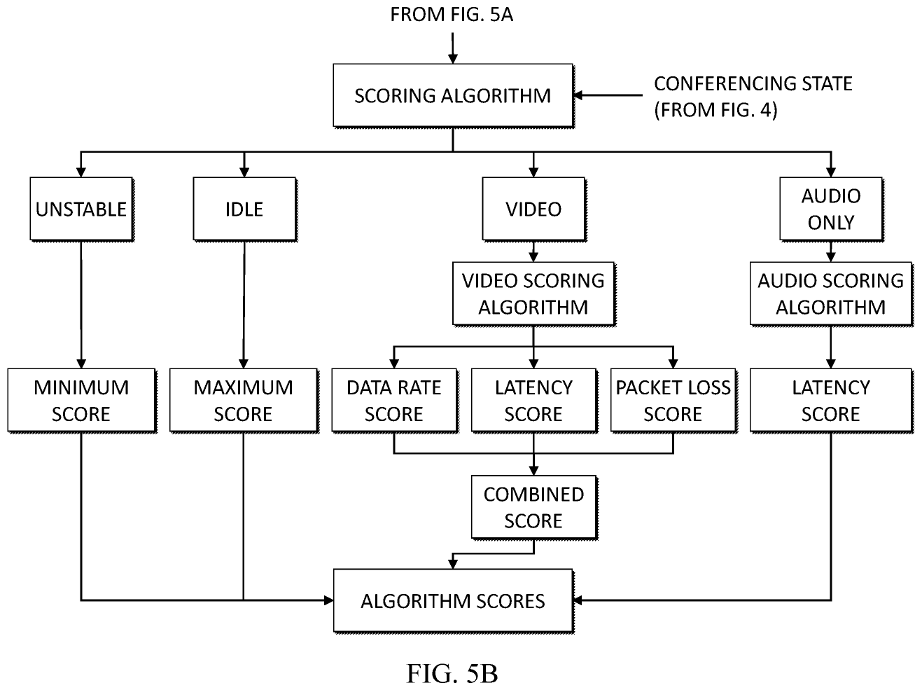

FIG. 5A shows an exemplary scoring flowchart according to some embodiments of the present technique. As can be seen, a respective scoring algorithm is applied to each of the top two data connections over the current time window separately. In addition, the respective scoring algorithm may be applied separately to each of the upstream and downstream data paths within each of the top two data connections.

In each case, the resulting upstream and downstream data path scores are combined based on predefined function or by applying predefined weights, to produce the combined score for each of the top two data connections. In some embodiments, the lowest of the upstream and downstream data path scores is selected in each case, as the combined scores for each of the top two data connections.

Similarly, the combined scores for the top two data connections are then combined themselves, based on a predefined function or by applying predefined weights, to produce the current conferencing service score 222 for the conferencing service instance. In some embodiments, the lowest of the final respective scores for the top two data connections is selected as the current conferencing service score 222 for the conferencing service instance.

FIG. 5B shows an exemplary scoring algorithm flowchart, according to some embodiments of the present disclosure. As noted above, the instructions of scoring module 206c may cause system 200 to apply one or more scoring algorithms to the statistical metrics calculated in step 310 with respect to the current time window, to calculate one or more corresponding current conferencing service scores. In some embodiments, the scoring algorithms selected for application by scoring module 206c may be determined based on the predicted conferencing connection state of current time window, as determined in step 310.

### Video Conferencing Score Calculation

With continued reference to FIG. 5B, when the conferencing status with respect to a current time window determined in step 308 is ‘video,’ the instructions of scoring module 206c may cause system 200 to call a corresponding video scoring algorithm configured to score a conferencing service instance in which the data traffic is associated with both video and audio transmission. In some embodiments, a scoring algorithm of the present technique configured to score a conferencing service instance, in which the data traffic is associated with both video and audio transmission, is based, at least in part, on the metrics with respect to data rate, latency, and/or packet loss rate, as calculated in step 310. In some embodiments, the video scoring algorithm is configured to generate at least the following respective scores:
(i) Data rate score: The data rate score is based on metrics associated with data rate (as calculated in step 310), and is generated by applying a combination of linear functions to calculate an overall data rate score on a scale of between 0-100.
(ii) Latency score: The latency score is based on the latency metrics calculated in step 310, by applying a predefined multivariate scoring function to the latency metrics calculated in step 310, to calculate an overall latency score on a scale of between 0-100. In some embodiments, a predetermined latency score (e.g., overall minimum latency score of 0) may be assigned in cases of no response to the latency tests from the target host. Another predetermined latency score (e.g., a maximum overall latency score of 100) may be assigned when the latency metrics that are consistent with minimal latency and delay over the conferencing service instance, e.g., latency metrics that are below a predetermined threshold representing minimal latency and delay.
(iii) Packet Loss rate score: The packet loss rate score is calculated by inputting the metrics calculated in step 310 into a monotonical one-variable function which assigns a score on a scale of 0-100. In some embodiments, a predetermined score (e.g., a minimum overall Packet Loss Score of 0) may be assigned in cases of a loss rate of 100%, i.e., when virtually all packets are lost. Conversely, another predetermined Packet Loss Score (e.g., a maximum overall score of 100) may be assigned in cases of a loss rate of 0%, i.e., when virtually all packets reach their destination. This variable was selected because dropped packets result in loss of data on the user side and can have a negative effect on the reconstructed video quality.

As can be seen in the example of FIGS. 5A and 5B, the video scoring algorithm is applied separately to each of the top two data connections, and may be further applied separately in each of the upstream and downstream data paths comprising each of the top two data connections.

In each case, the score for each of the upstream and downstream data paths is calculated based on a predefined function or by applying predefined weights to the data rate score and the latency score calculated as detailed immediately above. In some embodiments, the score for each of the upstream and downstream data paths is calculated by selected the lowest of the data rate score and the latency score calculated as detailed immediately above. Then, the resulting score is combined with the packet loss rate score calculated as detailed immediately above, based on a predefined function, by applying predefined weights, or by selecting the lowest of the combined data rate/latency score and the packet loss rate score, to produce the current video conferencing score for each of the upstream and downstream data paths in each of the top two data connections.

With continued reference to FIGS. 5A and 5B, the resulting video conferencing scores for each of the upstream and downstream data paths are combined based on a predefined function, by applying predefined weights, or by selecting the lowest thereof, to produce the current video conferencing scores for each of the top two data connections. Then, the combined video conferencing score for the top two data connections are further combined, based on a predefined function, by applying predefined weights, or by selecting the lowest thereof, to produce the current conferencing service score 222 for the conferencing service instance.

### Audio-Only Conferencing Score Calculation

In some embodiments, when the conferencing status with respect to a current time window determined in step 308 is ‘audio,’ the instructions of scoring module 206c may cause system 200 to call a corresponding audio-only scoring algorithm configured to score a conferencing service instance in which the data traffic is associated with only audio transmission. In some embodiments, a scoring algorithm of the present technique configured to score a conferencing service instance, in which the data traffic is associated with only audio transmission, is based, at least in part, on the metrics with respect to latency as calculated in step 310. In some embodiments, the audio-only scoring algorithm is configured to generate at least the following respective scores:
Latency score: The latency score is based on the latency metrics calculated in step 310, by applying a predefined multivariate scoring function to the latency metrics calculated in step 310, to calculate an overall latency score on a scale of between 0-100. In some embodiments, a predetermined score (e.g., an overall minimum latency score of 0) may be assigned in cases of no response to the latency tests from the target host. Another predetermined latency score (e.g., a maximum overall latency score of 100) may be assigned when the latency metrics that are consistent with minimal latency and delay over the conferencing service instance, e.g., latency metrics that are below a predetermined threshold representing minimal latency and delay.

As can be seen in FIGS. 5A and 5B, the audio-only scoring algorithm is applied separately to each of the top two data connections, and separately in each of the upstream and downstream data paths comprising each of the top two data connections.

In some embodiments, the scores for each of the upstream and downstream data paths are combined based on a predefined function, by applying predefined weights, or by selecting the lowest thereof, to produce the current audio-only conferencing scores for each of the top two data connections. Then, the current audio-only conferencing scores for the top two data connections are combined, based on a predefined function, by applying predefined weights, or by selecting the lowest thereof, to produce the current conferencing service score 222 for the conferencing service instance.

### Unstable and Unknow/Idle Conferencing Score Calculation

In some embodiments, when the conferencing status with respect to a current time window determined in step 308 is ‘unstable,’ the instructions of scoring module 206c may cause system 200 to assign a minimal score of zero as the final conferencing score 222 for the conferencing service instance.

In some embodiments, when the conferencing status with respect to a current time window determined in step 308 is ‘idle,’ the instructions of scoring module 206c may cause system 200 to assign a predetermined score (e.g., maximal score of 100) as the final conferencing score 222 for the conferencing service instance

Finally, in step 314, the instructions of scoring module 206c may cause system 200 to assess, based on the current conferencing service score 222, a current Quality of Service (QoS) rating associated with the conferencing service instance, as one of:
Satisfactory Status (Score 75-100): The conferencing service instance provides good QoE.
Advisory Status (Score 50-74): The conferencing service instance currently provides good QoE, however, the QoE is unstable and may be negatively impacted in the case of an increase in network data traffic or similar factors.
Critical Status (Score 25-49): The conferencing service instance provides inadequate QoE.
Inoperative Status (Score 0-24): The conferencing service instance is inoperative, such that an end-deice is unable to connect to a conferencing platform, experiences frequent disconnections, and/or unable to execute a conferencing application which requires a real-time data connection.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least one hardware processor; and
a non-transitory computer-readable storage medium having stored thereon program instructions, the program instructions executable by the at least one hardware processor to:
receive, at a communications network interface, telemetry data representing data connections associated with a conferencing service instance provided to an end-device by a remote conferencing server over the Internet,
select a subset of said data connections, based on data traffic measurements associated with each of said data connections,
recursively, with respect to each current time window:
(i) calculate data rate and packet roundtrip metrics from said telemetry data over each data connection in said subset,
(ii) determine a conferencing state of said conferencing service instance, based, at least in part, on said data rate metrics,
(iii) determine a current conferencing service score for said conferencing service instance, based on applying respective scoring algorithms to said calculated metrics, wherein said scoring algorithms are selected based on said determined conferencing state,
(iv) update a quality of service (QoS) rating for said conferencing service instance based, at least in part, on said current conferencing service score, and
(v) repeat steps (i)-(iv) with respect to a next time window.

2. The system of claim 1, wherein said subset of data connections comprises between 1-8 data connections.

3. The system of claim 1, wherein, when said determined conferencing state comprises both video and audio transmission, said current conferencing service score is equal to a weighted combination of data connection scores calculated with respect to each of said data connections in said subset.

4. The system of claim 3, wherein, with respect to each of said data connections in said subset, said data connection score is a weighted combination of (i) a data rate score calculated based on said data rate metrics, and (ii) a latency score calculated based on said packet roundtrip metrics.

5. The system of claim 4, wherein said data connection score is further based on a packet loss score calculated based on packet loss metrics calculated from said telemetry data over each data connection in said subset, wherein said data connection is a weighted combination of (i) said packet loss score and (ii) said weighted combination of said data rate and latency scores.

6. The system of claim 5, wherein said data connection score is a weighted combination of said data connection scores calculated separately with respect to each of an upstream and a downstream data paths in a respective data connection.

7. The system of claim 1, wherein, when said determined conferencing state comprises only audio transmission, said current conferencing service score is equal to a weighted combination of latency scores calculated based on said packet roundtrip metrics with respect to each of said data connections in said subset.

8. The system of claim 1, wherein, when said determined conferencing state does not comprise video or audio transmission, said current conferencing score is set to a maximum value.

9. The system of claim 1, wherein, when said determined conferencing state fluctuates between two or more conferencing states, said current conferencing score is set to a minimum value.

10. A computer-implemented method comprising:
receiving, at a communications network interface, telemetry data representing data connections associated with a conferencing service instance provided to an end-device by a remote conferencing server over the Internet;
selecting a subset of said data connections, based on data traffic measurements associated with each of said data connections;
recursively, with respect to each current time window:
(i) calculating data rate and packet roundtrip metrics from said telemetry data over each data connection in said subset,
(ii) determining a conferencing state of said conferencing service instance, based, at least in part, on said data rate metrics,
(iii) determining a current conferencing service score for said conferencing service instance, based on applying respective scoring algorithms to said calculated metrics, wherein said scoring algorithms are selected based on said determined conferencing state,
(iv) updating a quality of service (QoS) rating for said conferencing service instance based, at least in part, on said current conferencing service score, and
(v) repeating steps (i)-(iv) with respect to a next time window.

11. The computer-implemented method of claim 10, wherein, when said determined conferencing state comprises both video and audio transmission, said current conferencing service score is equal to a weighted combination of data connection scores calculated with respect to each of said data connections in said subset.

12. The computer-implemented method of claim 11, wherein, with respect to each of said data connections in said subset, said data connection score is a weighted combination of (i) a data rate score calculated based on said data rate metrics, and (ii) a latency score calculated based on said packet roundtrip metrics.

13. The computer-implemented method of claim 12, wherein said data connection score is further based on a packet loss score calculated based on packet loss metrics calculated from said telemetry data over each data connection in said subset, wherein said data connection is a weighted combination of (i) said packet loss score and (ii) said weighted combination of said data rate and latency scores.

14. The computer-implemented method of claim 13, wherein said data connection score is a weighted combination of said data connection scores calculated separately with respect to each of an upstream and a downstream data paths in a respective data connection.

15. The computer-implemented method of claim 10, wherein, when said determined conferencing state comprises only audio transmission, said current conferencing service score is equal to a weighted combination of latency scores calculated based on said packet roundtrip metrics with respect to each of said data connections in said subset.

16. The computer-implemented method of claim 10, wherein, when said determined conferencing state does not comprise video or audio transmission, said current conferencing score is set to a maximum value.

17. The computer-implemented method of claim 10, wherein, when said determined conferencing state fluctuates between two or more conferencing states, said current conferencing score is set to a minimum value.

18. A computer program product comprising a non-transitory computer-readable storage medium having program instructions embodied therewith, the program instructions executable by at least one hardware processor to:
receive, at a communications network interface, telemetry data representing data connections associated with a conferencing service instance provided to an end-device by a remote conferencing server over the Internet;
select a subset of said data connections, based on data traffic measurements associated with each of said data connections;
recursively, with respect to each current time window:
(i) calculate data rate and packet roundtrip metrics from said telemetry data over each data connection in said subset,
(ii) determine a conferencing state of said conferencing service instance, based, at least in part, on said data rate metrics,
(iii) determine a current conferencing service score for said conferencing service instance, based on applying respective scoring algorithms to said calculated metrics, wherein said scoring algorithms are selected based on said determined conferencing state,
(iv) update a quality of service (QoS) rating for said conferencing service instance based, at least in part, on said current conferencing service score, and
(v) repeat steps (i)-(iv) with respect to a next time window.

19. The computer program product of claim 18, wherein, when said determined conferencing state comprises both video and audio transmission, said current conferencing service score is equal to a weighted combination of data connection scores calculated with respect to each of said data connections in said subset, and wherein respect to each of said data connections in said subset, said data connection score is a weighted combination of (i) a data rate score calculated based on said data rate metrics, and (ii) a latency score calculated based on said packet roundtrip metrics.

20. The computer program product of claim 19, wherein said data connection score is further based on a packet loss score calculated based on packet loss metrics calculated from said telemetry data over each data connection in said subset, wherein said data connection is a weighted combination of (i) said packet loss score and (ii) said weighted combination of said data rate and latency scores.
